(19) United States
(12) Patent Application Publication
(10) Pub. No.: US 2014/0015741 A1
(43) Pub. Date: Jan. 16, 2014

(54) PROGRAMMABLE GAMMA CIRCUIT FOR LCD DISPLAY DEVICE AND RELATED METHOD AND DRIVER CIRCUIT

(71) Applicant: Richtek Technology Corporation, Hsinchu County (TW)

(72) Inventors: Der-Jiunn WANG, Hsinchu County (TW); Tien-Jung WU, Yunlin County (TW)

(21) Appl. No.: 13/925,308

(22) Filed: Jun. 24, 2013

(30) Foreign Application Priority Data
Jul. 13, 2012 (TW) 101125465

(51) Int. Cl. G09G 3/36

(52) U.S. Cl. CPC G09G 3/36
USPC 345/88

(57) ABSTRACT

A programmable Gamma circuit of a LCD display device includes a control signal generator for generating multiple control signals; one or more voltage-reducing circuits for generating multiple voltage-reduced signals corresponding to a common voltage feedback signal outputted from a LC array of the LCD display device; and multiple amplifying circuits for respectively amplifying the multiple coupled signals to generate multiple Gamma calibration signals. The multiple voltage-reduced signals are respectively coupled with the multiple control signals to generate multiple coupled signals.

### CROSS-REFERENCE TO RELATED APPLICATIONS

This application claims the benefit of priority to Patent Application No. 101125465, filed in Taiwan on Jul. 13, 2012; the entirety of which is incorporated herein by reference for all purposes.

### BACKGROUND

The disclosure generally relates to a LCD display device and, more particularly, to a programmable Gamma circuit for use in the LCD display device and related method and driving circuit.

Generally, a programmable Gamma circuit is typically arranged in a LCD display device to generate Gamma calibration signals for use in an image Gamma calibration. A source driving circuit generates driving signals required by the LCD display device according to the Gamma calibration signals so as to enable the LED display device to present required brightness.

In operations, the actual brightness of the LCD display device is affected by a common reference voltage signal generated by a timing circuit in the LCD display device. Specifically, the brightness of images is related to a difference between the Gamma calibration signal and the common reference voltage signal.

However, when the load of the LCD display device changes, for example, when the screen of the LCD display device is carrying out the dark-to-bright transition or the bright-to-dark transition, it easily results in ripples in the common reference voltage, thereby causing the brightness of the images displayed on the LCD display device to deviate from the ideal situation. As a result, it would cause the problems of image distortion.

### SUMMARY

An example embodiment of a programmable Gamma circuit for use in a LCD display device is disclosed, comprising: a control signal generator, configured to operably generate multiple control signals; one or more voltage-reducing circuits, configured to operably generate multiple voltage-reduced signals corresponding to a common voltage feedback signal outputted from a LC array of the LCD display device, wherein the multiple voltage-reduced signals are respectively coupled with the multiple control signals for generating multiple coupled signals; and multiple amplifying circuits, configured to respectively amplify the multiple coupled signals to generate multiple Gamma calibration signals.

An example embodiment of a method for generating Gamma calibration signals of a LCD display device is disclosed, comprising: generating multiple control signals; generating multiple voltage-reduced signals corresponding to a common voltage feedback signal outputted from a LC array of the LCD display device; respectively coupling the multiple voltage-reduced signals with the multiple control signals to generate multiple coupled signals; and respectively amplifying the multiple coupled signals to generate multiple Gamma calibration signals.

An example embodiment of a driving circuit for use in a LCD display device is disclosed, comprising: a control signal generator, configured to operably generate multiple control signals; one or more voltage-reducing circuits, configured to operably generate one or more voltage-reduced signals corresponding to a common voltage feedback signal outputted from a LC array of the LCD display device, wherein the one or more voltage-reduced signals are respectively coupled with the multiple control signals for generating multiple coupled signals; multiple amplifying circuits, configured to respectively amplify the multiple coupled signals to generate multiple Gamma calibration signals; and a driving signal generator, coupled with the multiple amplifying circuits, configured to operably generate multiple driving signals according to the multiple Gamma calibration signals.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a LCD display device according to one embodiment of the present disclosure.

FIG. 2 shows a simplified functional block diagram of each voltage-reducing circuit of FIG. 1 according to one embodiment of the present disclosure.

FIG. 3 shows a simplified schematic diagram of a Gamma calibration signal generated by a programmable Gamma circuit of FIG. 1 according to one embodiment of the present disclosure.

FIG. 4 shows a simplified functional block diagram of each voltage-reducing circuit of FIG. 1 according to another embodiment of the present disclosure.

FIG. 5 shows a simplified functional block diagram of a LCD display device according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

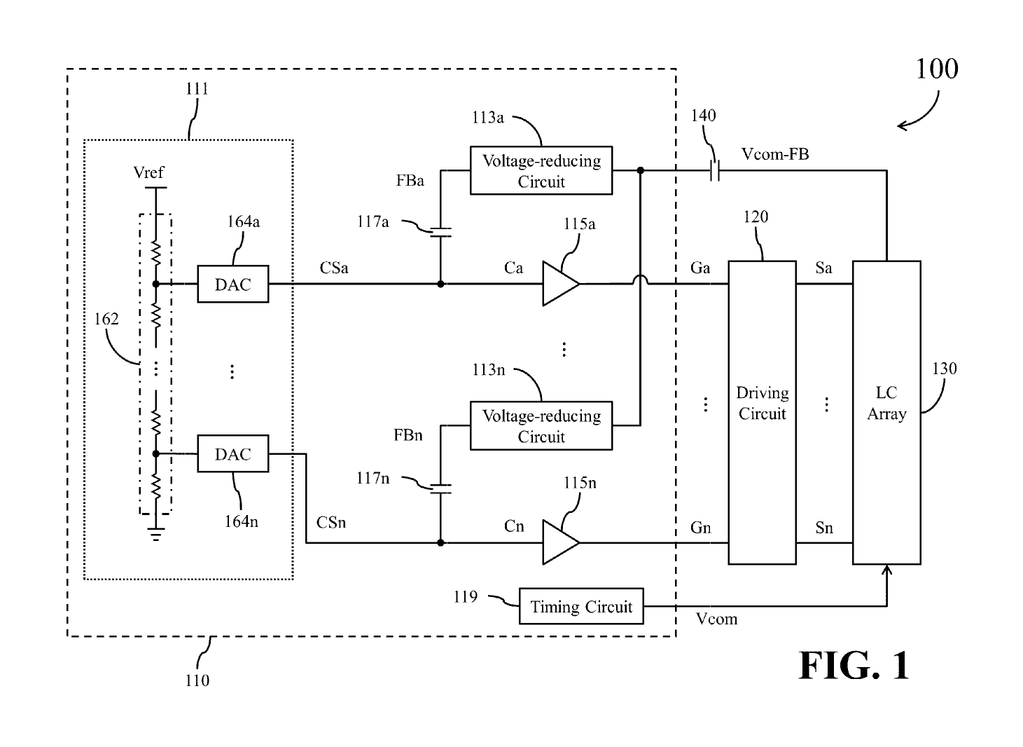

FIG. 1 shows a simplified functional block diagram of a LCD display device 100 according to one embodiment of the present disclosure. The LCD display device 100 comprises a programmable Gamma circuit 110, a driving circuit 120, a LC array 130, and a capacitor 140. In operations, the programmable Gamma circuit 110 generates multiple Gamma calibration signals (e.g., the example signals Ga˜Gn shown in FIG. 1), and a common reference voltage signal Vcom. The driving circuit 120 is coupled with the programmable Gamma circuit 110 and configured to operably generate multiple driving signals (e.g., the example signals Sa˜Sn shown in FIG. 1) according to the Gamma calibration signals Ga˜Gn. The LC array 130 is formed by multiple pixels and coupled with the driving circuit 120. The LC array 130 is configured to operably display corresponding images according to the multiple driving signals Sa˜Sn. The LC array 130 also outputs a common voltage feedback signal Vcom-FB. In this embodiment, the capacitor 140 is coupled between an output terminal of the LC array 130 and the programmable Gamma circuit 110. The capacitor 140 is configured to operably couple the common reference voltage signal Vcom outputted from the LC array 130 with the programmable Gamma circuit 110. The use of the capacitor 140 may reduce the noise in the common voltage feedback signal Vcom-FB.

In practice, different functional blocks in the LCD display device 100 may be integrated into a single circuit chip, or may be respectively realized with different circuits. For example, the programmable Gamma circuit 110 and the driving circuit 120 in the LCD display device 100 may be integrated into a single circuit chip, or may be realized with two separate circuit chips.

For the purpose of explanatory convenience, other components in the LCD display device 100 and related connections are not shown in FIG. 1.

In the embodiment of FIG. 1, the programmable Gamma circuit 110 comprises a control signal generator 111, multiple voltage-reducing circuits (e.g., the example circuits 113a˜113n shown in FIG. 1), multiple amplifying circuits (e.g., the example circuits 115a˜115n shown in FIG. 1), multiple capacitors (e.g., the example capacitors 117a˜117n shown in FIG. 1), and a timing circuit 119. The control signal generator 111 is configured to operably generate multiple control signals (e.g., the example signals CSa˜CSn shown in FIG. 1). The voltage-reducing circuits 113a˜113n are configured to operably generate multiple voltage-reduced signals FBa˜FBn corresponding to the common voltage feedback signal Vcom-FB, and the voltage swing of each of the voltage-reduced signals FBa˜FBn is smaller than the voltage swing of the common reference voltage signal Vcom and also smaller than the voltage swing of the common voltage feedback signal Vcom-FB. As shown in FIG. 1, the voltage-reduced signals FBa˜FBn are respectively coupled with the control signals CSa˜CSn for generating multiple coupled signals Ca˜Cn. The amplifying circuits 115a˜115n are configured to respectively amplify the coupled signals Ca˜Cn to generate multiple Gamma calibration signals Ga˜Gn. The capacitors 117a˜117n are respectively coupled among the voltage-reducing circuits 113a˜113n and the amplifying circuits 115a˜115n. The capacitors 117a˜117n are configured to operably reduce the noises in the multiple voltage-reduced signals FBa˜FBn. The timing circuit 119 is coupled with an input terminal of the LC array 130 and configured to operably generate the common reference voltage signal Vcom required for the operations of the LC array 130.

In this embodiment, the driving circuit 120 comprises a driving signal generator (not shown in FIG. 1) coupled with the amplifying circuits 115a˜115n and configured to operably generate the multiple driving signals Sa˜Sn according to the Gamma calibration signals Ga˜Gn. In practice, the driving signals Sa˜Sn may be source driving signals required for the operations of the LC array 130.

As shown in FIG. 1, the control signal generator 111 of this embodiment comprises a voltage-divider resistor string 162 and multiple digital-to-analog converters (DAC, e.g., the example DACs 115a˜115n shown in FIG. 1). The voltage-divider resistor string 162 comprises multiple voltage-divider resistors and is configured to operably generate multiple voltage-divided signals according to a reference voltage Vref. The DACs 164a˜164n generate the aforementioned control signals CSa˜CSn according to corresponding digital control signals (not shown) and the voltage-divided signals. In this embodiment, the voltage swing of the reference voltage Vref is smaller than the voltage swing of the common reference voltage signal Vcom and also smaller than the voltage swing of the common voltage feedback signal Vcom-FB, and thus the demand of voltage tolerance ability of the voltage-divider resistors in the voltage-divider resistor string 162 can be reduced.

For the purpose of explanatory convenience, other components in the programmable Gamma circuit 110 and related connections are not shown in FIG. 1.

Throughout the specification and drawings, indexes a˜n may be used in the reference numbers of components and devices for ease of referring to respective components and devices. The use of indexes a˜n does not intend to restrict the amount of components and devices to any specific number. In the specification and drawings, if a reference number of a particular component or device is used without having the index, it means that the reference number is used to refer to any unspecific component or device of corresponding component group or device group. For example, the reference number 113a is used to refer to the specific voltage-reducing circuit 113a, and the reference number 113 is used to refer to any unspecific voltage-reducing circuit of the voltage-reducing circuits 113a˜113n. In another example, the reference number FBa is used to refer to the specific voltage-reduced signal FBa, and the reference number FB is used to refer to any unspecific voltage-reduced signal of the voltage-reduced signals FBa˜FBn.

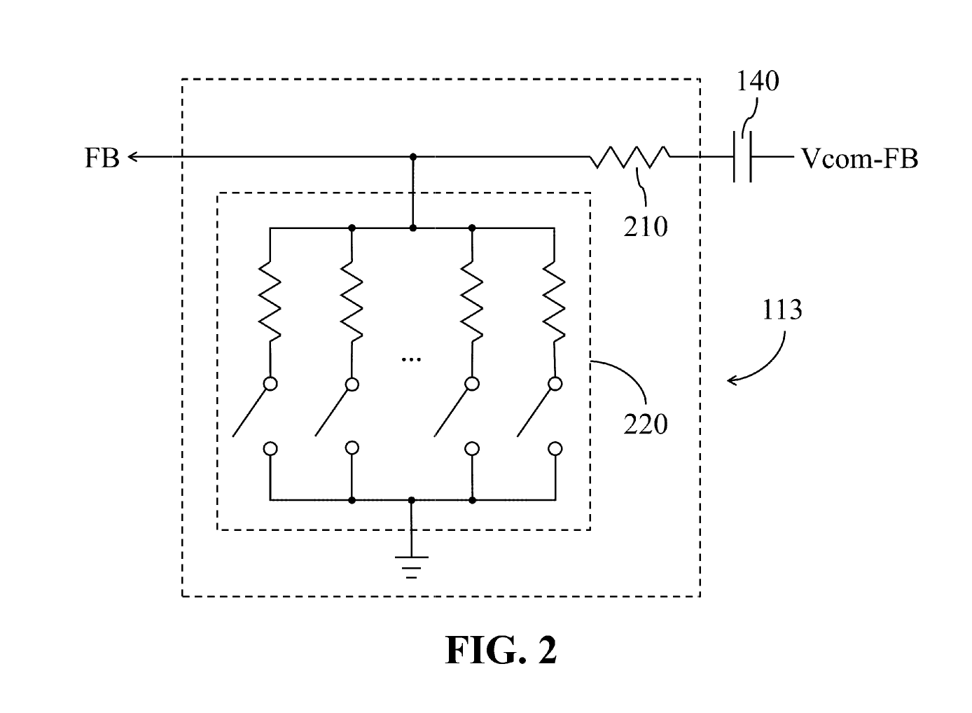

In practice, the multiple voltage-reducing circuits 113a˜113n in the programmable Gamma circuit 110 may be realized by multiple voltage-divider circuits. For example, FIG. 2 shows a simplified functional block diagram of each voltage-reducing circuit 113 of FIG. 1 according to one embodiment of the present disclosure. As shown in FIG. 2, the voltage-reducing circuit 113 is a voltage-divider circuit formed by a resistor 210 and an adjustable resistor device 220. In this embodiment, the adjustable resistor device 220 comprises multiple resistors in parallel connection and multiple switches in parallel connection, and the multiple switches in parallel connection are respectively coupled with the multiple resistors in parallel connection. In practice, each switch in the adjustable resistor device 220 may be realized by one or more transistors. In operations, control circuits (not shown) inside or outside the programmable Gamma circuit 110 may adjust the equivalent resistance of the adjustable resistor device 220 to change the magnitude of the voltage-reduced signal FB outputted from the voltage-reducing circuit 113 by controlling the number of turned-on switches in the adjustable resistor device 220.

In practice, depending on the requirement of circuit operations, the adjustable resistor devices 220 in different voltage-reducing circuits 113 may be configured to have the same equivalent resistance, so that different voltage-reducing circuits 113 have the same voltage-reducing effect. Alternatively, the adjustable resistor devices 220 in different voltage-reducing circuits 113 may be configured to have different equivalent resistances, so that different voltage-reducing circuits 113 have different voltage-reducing effects.

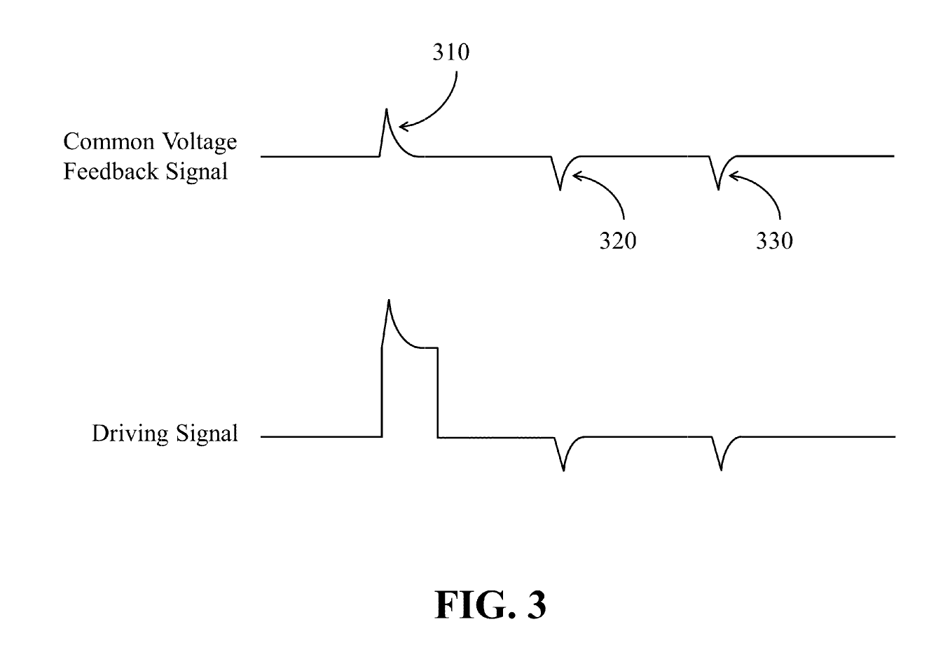

FIG. 3 shows a simplified schematic diagram of the Gamma calibration signal generated by the programmable Gamma circuit 110 according to one embodiment of the present disclosure. As described previously, changes in the load of the LCD display device 100 may interfere with the common reference voltage signal Vcom currently utilized by the LC array 130, and results in ripples in the common reference voltage signal Vcom. In this situation, corresponding ripples may appear in the common voltage feedback signal Vcom-FB outputted from the LC array 130.

As shown in FIG. 3, when the screen of the LCD display device 100 is carrying out the bright-to-dark transition, ripples similar to an illustrated wave form 310 may appear in the common voltage feedback signal Vcom-FB outputted from the LC array 130. When the screen of the LCD display device is carrying out the dark-to-bright transition, ripples similar to illustrated wave forms 320 or 330 may appear in the common voltage feedback signal Vcom-FB.

When the ripples occur in the common voltage feedback signal Vcom-FB, corresponding ripples would occur in the voltage-reduced signals FBa˜FBn generated by the voltage-reducing circuits 113a˜113n. However, due to the voltage-reducing operation conducted by the voltage-reducing circuits 113a˜113n, the amplitudes of the ripples in the voltage-reduced signals FBa˜FBn would be smaller than the amplitudes of the ripples in the common voltage feedback signal Vcom-FB.

As described previously, the voltage-reduced signals FBa˜FBn generated by the multiple voltage-reducing circuits 113a˜113n of the programmable Gamma circuit 110 are respectively coupled with the control signals CSa˜CSn for generating the multiple coupled signals Ca˜Cn. Accordingly, the coupled signals Ca˜Cn have signal components corresponding to the ripples in the common voltage feedback signal Vcom-FB

Since the amplifying circuits 115a˜115n respectively amplify the coupled signals Ca˜Cn to generate the multiple Gamma calibration signals Ga˜Gn, the Gamma calibration signals Ga˜Gn would thus have signal components identical or similar to the ripples in the common voltage feedback signal Vcom-FB. Therefore, as shown in FIG. 3, the driving signals Sa˜Sn generated by the driving circuit 120 in the subsequent stage according to the Gamma calibration signals Ga˜Gn have signal components identical or similar to the ripples in the common voltage feedback signal Vcom-FB.

Accordingly, through the operations of the aforementioned programmable Gamma circuit 110, it ensures that a difference between the driving signals Sa˜Sn and the common reference voltage signal Vcom currently utilized by the LC array 130 can be maintained the same or substantially the same. As a result, the accuracy of the brightness of the images displayed on the LCD display device 100 can be greatly increased.

In some embodiments, the space inside the housing of the LCD display device 100 is very limited, and thus does not allow installing too many circuit components inside the LCD display device 100. Since the aforementioned voltage-reducing circuits 113a˜113n conduct voltage-reducing operations on the common voltage feedback signal Vcom-FB to render the voltage swings of the resulting voltage-reduced signals FBa˜FBn smaller than the voltage swing of the common voltage feedback signal Vcom-FB. The required areas of the capacitors 117a˜117n can be therefore reduced, thereby effectively reducing the overall circuit area of the programmable Gamma circuit 110.

Additionally, as can be appreciated from the foregoing descriptions, since only a single capacitor 140 is required to be coupled between the output terminal of the LC array 130 and the programmable Gamma circuit 110, the required space is very small. Accordingly, when the LC array 130 of a given size is employed, the appearance size of the LCD display device 100 can be effectively reduced by adopting the structure of the disclosed programmable Gamma circuit 110. It is apparently that the disclosed programmable Gamma circuit 110 is very suitable to be applied in high-resolution LCD display devices.

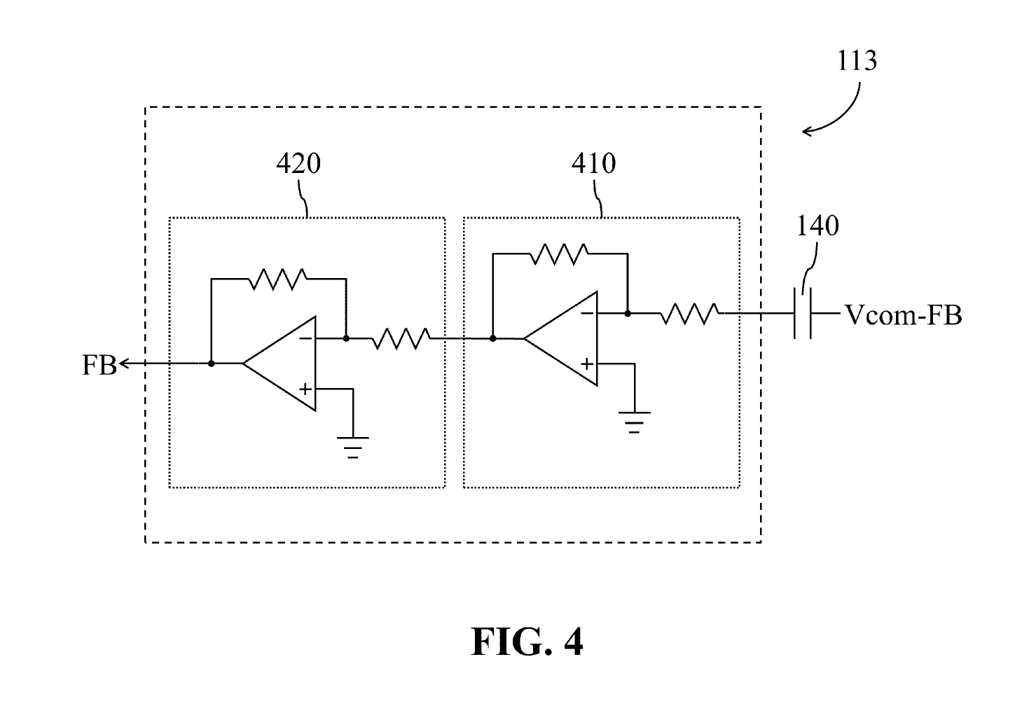

In practice, the voltage-reducing circuit 113 in the programmable Gamma circuit 110 may be realized with other circuits having the same or similar functionalities, and not restricted to the embodiment of FIG. 2. For example, FIG. 4 shows a simplified functional block diagram of each voltage-reducing circuit 113 of FIG. 1 according to another embodiment of the present disclosure. In the embodiment of FIG. 4, the voltage-reducing circuit 113 comprises amplifying circuits 410 and 420 adopting OP amplifiers, and the gain of each of the amplifying circuits 410 and 420 is smaller than one. Similar to the embodiment of FIG. 2, the voltage-reducing circuit 113 of FIG. 4 also conducts voltage-reducing operations on the common voltage feedback signal Vcom-FB to render the resulting voltage swings of the voltage-reduced signals FB smaller than the voltage swing of the common voltage feedback signal Vcom-FB.

Additionally, in some embodiments where the voltage-reducing circuit 113 is realized with the structure of FIG. 4, partial components in the voltage-reducing circuits 113a˜113n may be shared with each other, thereby reducing the number of components inside the programmable Gamma circuit 110. For example, the voltage-reducing circuits 113a˜113n may share a common amplifying circuit 410, while utilizing respective amplifying circuits 420.

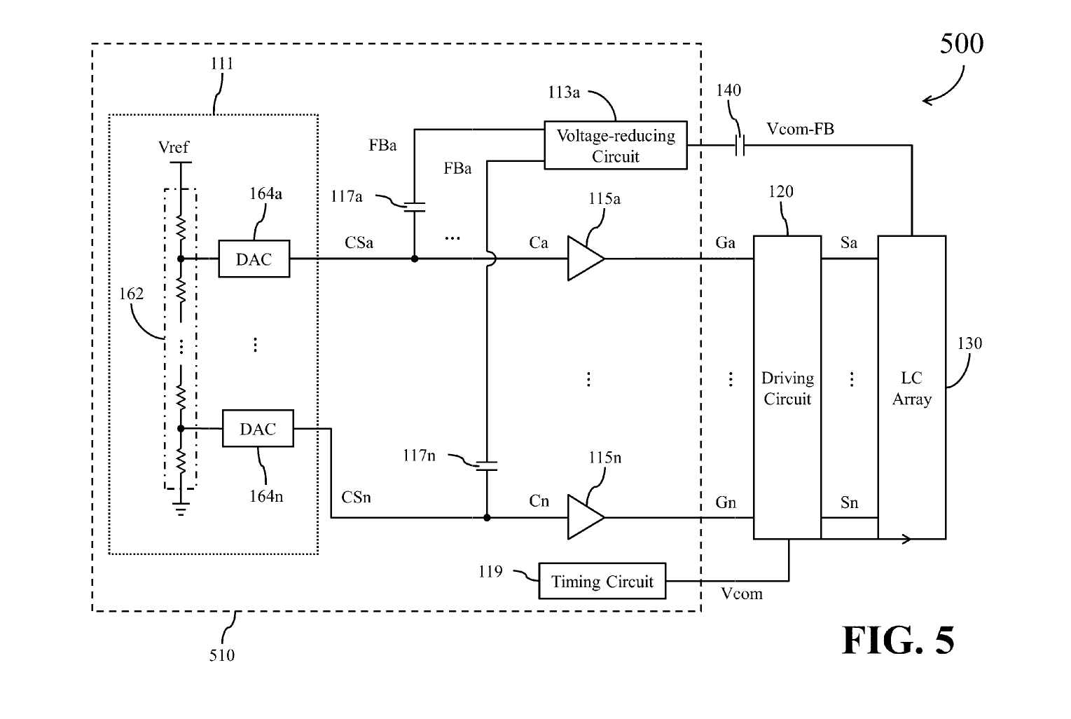

FIG. 5 shows a simplified functional block diagram of a LCD display device 500 according to another embodiment of the present disclosure. The LCD display device 500 is similar to the LCD display device 100 in FIG. 1, and the difference between the two embodiments is that only a single voltage-reducing circuit 113a is arranged in a programmable Gamma circuit 510 of the LCD display device 500. As shown in FIG. 5, the voltage-reducing circuit 113a conducts voltage-reducing operations on the common voltage feedback signal Vcom-FB to generate multiple voltage-reduced signals FBa of the same magnitude, and respectively outputs the multiple voltage-reduced signals FBa to the capacitors 117a˜117n. The descriptions regarding the implementations, the operations, and the related advantages of other functional blocks of the LCD display device 100 of FIG. 1 are also applicable to the LCD display device 500 of FIG. 5. For simplicity, the descriptions will not be repeated here.

In comparison with the programmable Gamma circuit 110 of FIG. 1, the structure of the programmable Gamma circuit 510 of FIG. 5 may further reduce the number of required components, and is thus more beneficial to reducing the required circuit area of the programmable Gamma circuit 510.

Similar to the aforementioned embodiments, the programmable Gamma circuit 510 and the driving circuit 120 in the LCD display device 500 may be integrated into a single circuit chip, or may be respectively realized with different circuits.

In practice, in each of the aforementioned embodiments, the amplifying circuits 115a˜115n positioned in different Gamma calibration signal tunnels may be configured to have the same gain bigger than one. Alternatively, according to characteristics of the Gamma calibration curve, the amplifying circuits 115a˜115n may be configured to have different gains, so that the different Gamma calibration signal tunnels have different signal magnifications, thereby improving the accuracy of the Gamma calibration. For example, the amplifying circuits 115a and 115n may be configured to have an identical first gain, and the amplifying circuit 115g may be configured to have a different second gain.

Additionally, in some embodiments, the aforementioned capacitor 140 may be omitted to further reduce the required circuit area of the LCD display device 100 or 500.

As can be appreciated from the foregoing descriptions, the disclosed programmable Gamma circuit 110 or 510 ensures that a difference between the driving signals Sa˜Sn and the common reference voltage signal Vcom currently utilized by the LC array 130 can be maintained the same or substantially the same, and thus the accuracy of the brightness of the images displayed on the LCD display device 100 or 500 can be greatly increased.

In addition, of the use of the voltage-reducing circuit 113 effectively reduces the required areas of the capacitors 117a˜117n, thereby effectively reducing the overall circuit area of the programmable Gamma circuit 110 or 510.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims

What is claimed is:

1. A programmable Gamma circuit for use in a LCD display device, comprising:
a control signal generator, configured to operably generate multiple control signals;
one or more voltage-reducing circuits, configured to operably generate multiple voltage-reduced signals corresponding to a common voltage feedback signal outputted from a LC array of the LCD display device, wherein the multiple voltage-reduced signals are respectively coupled with the multiple control signals for generating multiple coupled signals; and
multiple amplifying circuits, configured to respectively amplify the multiple coupled signals to generate multiple Gamma calibration signals.

2. The programmable Gamma circuit of claim 1, further comprising:
multiple capacitors, each of which being coupled among the multiple amplifying circuits and the one or more voltage-reducing circuits.

3. The programmable Gamma circuit of claim 1, wherein the control signal generator comprises multiple digital-to-analog converters for generating the multiple control signals.

4. The programmable Gamma circuit of claim 1, wherein the multiple voltage-reducing circuits are multiple voltage divider circuits.

5. The programmable Gamma circuit of claim 1, wherein each of the multiple voltage-reducing circuits comprises an adjustable resistor device.

6. The programmable Gamma circuit of claim 5, wherein the adjustable resistor device comprises:
multiple resistors in parallel connection; and
multiple switches in parallel connection, respectively coupled with the multiple resistors in parallel connection.

7. The programmable Gamma circuit of claim 1, wherein the multiple amplifying circuits have a same gain.

8. The programmable Gamma circuit of claim 1, wherein at least one of the multiple amplifying circuits has a gain different form that of the other amplifying circuits of the multiple amplifying circuits.

9. The programmable Gamma circuit of claim 1, wherein the programmable Gamma circuit comprises only one voltage-reducing circuit.

10. The programmable Gamma circuit of claim 1, wherein the programmable Gamma circuit comprises multiple voltage-reducing circuits.

11. A method for generating Gamma calibration signals of a LCD display device, comprising:
generating multiple control signals;
generating multiple voltage-reduced signals corresponding to a common voltage feedback signal outputted from a LC array of the LCD display device;
respectively coupling the multiple voltage-reduced signals with the multiple control signals to generate multiple coupled signals; and
respectively amplifying the multiple coupled signals to generate multiple Gamma calibration signals.

12. A driving circuit for use in a LCD display device, comprising:
a control signal generator, configured to operably generate multiple control signals;
one or more voltage-reducing circuits, configured to operably generate one or more voltage-reduced signals corresponding to a common voltage feedback signal outputted from a LC array of the LCD display device, wherein the one or more voltage-reduced signals are respectively coupled with the multiple control signals for generating multiple coupled signals;
multiple amplifying circuits, configured to respectively amplify the multiple coupled signals to generate multiple Gamma calibration signals; and
a driving signal generator, coupled with the multiple amplifying circuits, configured to operably generate multiple driving signals according to the multiple Gamma calibration signals.

13. The driving circuit of claim 12, further comprising:
multiple capacitors, each of which being coupled among the multiple amplifying circuits and the one or more voltage-reducing circuits.

14. The driving circuit of claim 12, wherein the control signal generator comprises multiple digital-to-analog converters for generating the multiple control signals.

15. The driving circuit of claim 12, wherein the multiple voltage-reducing circuits are multiple voltage-divider circuits.

16. The driving circuit of claim 12, wherein each of the multiple voltage-reducing circuits comprises an adjustable resistor device.

17. The driving circuit of claim 16, wherein the adjustable resistor device comprises:
multiple resistors in parallel connection; and
multiple switches in parallel connection, respectively coupled with the multiple resistors in parallel connection.

18. The driving circuit of claim 12, wherein the multiple amplifying circuits have a same gain.

19. The driving circuit of claim 12, wherein at least one of the multiple amplifying circuits has a gain different from that of the other amplifying circuits of the multiple amplifying circuits.

20. The driving circuit of claim 12, wherein the driving circuit comprises only one voltage-reducing circuit.

21. The driving circuit of claim 12, wherein the driving circuit comprises multiple voltage-reducing circuits.
